(19) United States
(12) Patent Application Publication
(10) Pub. No.: US 2024/0256730 A1
(43) Pub. Date: Aug. 1, 2024

(54) CUSTOMIZED METHOD FOR STRENGTHENING THE WATER DROPLET EROSION RESISTANCE ON STEAM TURBINE BLADE SURFACES

(71) Applicant: Xi'an Jiaotong University, Xi'an (CN)

(72) Inventors: Yonghui XIE, Xi'an (CN); Zifeng CHEN, Xi'an (CN); Youxiang CHEN, Xi'an (CN); Bin YANG, Xi'an (CN); Di ZHANG, Xi'an (CN)

(73) Assignee: Xi'an Jiaotong University, Xi'an (CN)

(21) Appl. No.: 18/019,257

(22) PCT Filed: Dec. 20, 2022
(86) PCT No.: PCT/CN2022/140193

§ 371 Date: Feb. 2, 2023

(30) Foreign Application Priority Data
Jul. 18, 2022 (CN) 202210840832.9

(51) Int. Cl. G06F 30/20; G01N 17/00; G06F 111/10

(52) U.S. Cl. CPC G06F 30/20; G01N 17/00; G06F 2111/10

(57) ABSTRACT

A customized method for strengthening the water droplet erosion (WDE) resistance on steam turbine blade surfaces having the following steps: step S1: carrying out numerical analysis about erosion characteristics on blade surfaces to predict water erosion prone areas; Step S2: designing corresponding structures against WDE, and conducting a test for WDE characteristics of structures to screen effective structures; Step S3: according to the areas detected in Step S1, selecting a suitable and effective structure from the test and determining where and how to arrange the structure on the blade surface is disclosed. The above-mentioned method can detect areas prone to blade erosion by numerical simulation, and arrange the structures screened out by test of WDE characteristics to improve the WDE resistance of blades, mitigating the WDE problem so only a small number of special structures in local areas are arranged, thereby minimizing cost and influence on steam turbine blades.

### CROSS REFERENCE TO THE RELATED APPLICATIONS

This application is the national stage entry of International Application No. PCT/CN2022/140193, filed on Dec. 20, 2022, which is based on and claims priority to Chinese Application No. 202210840832.9, filed Jul. 18, 2022, the entire contents of which are incorporated herein by reference.

### TECHNICAL FIELD

The present invention relates to the technical field of industrial equipment, in particular, a customized method for strengthening the water droplet erosion resistance on steam turbine blade surfaces.

### BACKGROUND

With the proposal of carbon peaking and carbon neutrality, the installed capacity of renewable energy power generation in the future is bound to usher in greater growth. However, wind power and photovoltaic power generation have strong intermittency and randomness, and their large-scale grid-connection will bring great challenges to the safety and stability of the power grid. In order to cope with the new situation of the power system, coal-fired power plants are undertaking more and more peak shaving tasks. Low load operation of steam turbine units has become a new normal, which causes the increase of humidity in the turbine flow passage and the frequent occurrence of water droplet erosion (WDE) on blades. As a result, the blade profile will be damaged and the stage efficiency will decrease. Also, the blade fracture in severe cases may cause a vital accident.

In general, there are two kinds of strategies for preventing WDE, which can be described as active and passive methods. Active methods generally improve the blade profile to reduce the geometric size and amount of droplets, or use dehumidification devices to remove harmful droplets. Common methods include: using rotating centrifugal force to remove water droplet in the cascade channel, using honeycomb seal, using inter-stage steam extraction, etc. Passive methods mostly use high resistant materials for WDE, and strengthen the rotor blade outlet edge or cover with coating for protection. These methods can ensure that blades safely operate under the long-term water droplet scouring during its normal working life. At present, these methods are also commonly used by major steam turbine manufacturers at home and abroad.

Although the application of passive method is very extensive, the protection effect of strengthening treatment or coating has great uncertainty. Under different operating conditions, there are great differences in the impact between harmful droplets and blades, resulting in different eroded areas. In order to ensure the safety of blade, it is essential to increase the strengthening or coating coverage area, which also increases the manufacturing cost of blade. And the protection effect of coating is greatly affected by the manufacturing process, sometimes the coating will fall off and lose the protection effect. In order to reduce the cost and improve the anti-erosion effect of blade, a method to solve the WDE problem of actual steam turbine blade is urgently needed.

### SUMMARY

The purpose of the present invention is to provide a customized method for strengthening the WDE resistance on steam turbine blade surfaces. First, numerically simulating to predict the areas prone to water erosion, then arranging optimally the water droplet corrosion resistant structures selected from the test to these areas, so as to improve the WDE resistance of blades. It is more targeted and only a few special structures are arranged in local areas to reduce costs.

To achieve the purpose mentioned above, this patent provides a customized method for strengthening the WDE resistance on steam turbine blade surfaces in the following steps:
Step S1: numerically analyzing surface erosion characteristics of the blade to be optimized, and predicting water erosion-prone areas on the surface of the blade to be optimized.
Step S2: designing the corresponding structures against WDE, and conducting the test for WDE characteristics of structures to screen the effective ones.
Step S3: according to the areas detected in Step S1, selecting a suitable and effective structure and determining where and how to arrange.

Preferably, step S1 specifically comprises:
Step S11, obtaining the model and operating condition parameters of the last stage;
Step S12: carrying out numerical simulation of the last stage flow passage in accord with parameters mentioned above to obtain the flow characteristics and humidity distribution of wet steam. As the WDE is mainly brought by secondary water droplets formed by torn water film near the trailing edge of stator blade, the aim of simulation is to acquire the deposition and movement characteristics of water film deposited on the surface near the trailing edge of stator blade.
Step S13: dividing the outlet of stator blade into several sections along radial direction and using it as the inlets for the simulation for erosion characteristics of rotor blade. Every section has its own inlet condition.
Step S14: based on the deposition and movement characteristics of water film acquired in step S12, and the shear force of the mainstream steam, the centrifugal force and the axial clearance between the stator and rotor blade, size and mass flow rate of the droplet corresponding to each section are calculated respectively.
Step S15: considering the motion of droplets in flow passage of rotor blade, droplets with size and mass flow rate calculated above are added to the corresponding inlet sections. Referring to the motion of mainstream steam at the inlet section and the motion difference between harmful droplets and mainstream, adding droplets at the corresponding section.
Step S16: determining the control parameters of the Finnie material erosion correction model according to mechanical properties of blade materials. Based on the movement of droplets in flow passage of rotor blade combined with Finnie erosion model, numerical simulation is conducted to obtain the erosion characteristics on rotor blade surfaces, particularly the erosion rate distribution of rotor blade surfaces, so as to determine the water erosion-prone area on the blade surface.

Preferably, the mentioned operating conditions parameters include rotational speed, inlet total pressure, inlet total temperature, inlet humidity and outlet pressure.

Preferably, step S2 is specified as:
Step S21: designing several structures against WDE.
Step S22: the impact parameters are obtained by numerical simulation of erosion characteristics in step S16.
Step S23: According to impact parameters obtained in step S22, adjusting parameters and dimensions of components in the experimental rig for testing WDE characteristics to adapt to conditions in the test.
Step S24: using cumulative volume loss and the dimensionless WDE resistance coefficient combined with macroscopic surface characteristics of the specimens to analyze the WDE resistance of different structures and rank the strength.
Step S25: screening out the most effective structure under the test condition.

Preferably, the impact parameters of droplets on blade surface include impact angle, relative impact velocity and droplet diameter. Parameters of each component include liquid-solid impact angle and liquid-solid impact velocity. Adjusting dimensions including droplet diameter.

Preferably, groove, stripe, dimple, protrusion and serrated structure are proposed considering droplet size when designing structures.

Preferably, in step S24,
the dimensionless WDE resistance coefficient is calculated as follows:

$${N}_{PE} = ( {E}_{1} / {E}_{10} + {E}_{2} / {E}_{20} ) / 2$$

Among them, N_{PE} is the dimensionless WDE resistance coefficient, E₁ [symbol] E₂ are the cumulative volume loss of a kind of structure specimen made by two different materials; E₁₀ and E₂₀ are the cumulative volume loss of flat specimen made by two different materials.

Therefore, a customized method for strengthening the WDE resistance on steam turbine blade surfaces has the following beneficial effects:

Compared with the traditional methods of surface strengthening or coating on rotor blade surfaces to prevent WDE, this method accurately predicts the water erosion-prone area on the blade surface through characteristic data analysis firstly, and then arranges customized structures on local areas to achieve reinforcement, which can reduce manufacturing cost of blades and to cope with the WDE problem efficiently.

When predicting the water erosion-prone area, the flow in whole stage is simulated to obtain the humidity distribution and wet steam flow characteristics of the outlet section of stator blade. Then, this section is taken as the inlet section, and droplets are added to simulate the flow passage of rotor blade to obtain the surface erosion characteristics of rotor blade. In comparison with the traditional numerical simulation, it can more accurately reflect the formation mode and trajectory of harmful droplets, which makes the numerical results more reliable.

The outlet of the stator blade is selected as the inlet section of the rotor during numerical simulation, and it is divided into several inlet sections with different humidity according to its radial humidity distribution. The droplet size and movement behavior are determined specifically, so that the numerical analysis results of erosion characteristics on blade surfaces are more accurate.

Under different conditions with different sizes and impact behaviors of harmful droplets, the test for WDE characteristics of structures is conducted, and the best one is selected for arranging on local areas.

When evaluating the WDE resistance of different structures, the traditional indicators such as maximum erosion rate or quality loss rate are not adopted, but the cumulative volume loss and dimensionless WDE resistance coefficient are adopted to rank the WDE resistance of different surface structures, which is more valuable for engineering application.

The technical scheme of this method will be further described in detail by the following figure and example.

### BRIEF DESCRIPTION OF THE DRAWINGS

FIG. 1 is a flow chart of a customized method for strengthening the WDE resistance on steam turbine blade surfaces.

FIG. 2 is a flow chart of numerical analysis about erosion characteristics on blade surfaces.

FIG. 3 is a flow chart of process to screen the most effective one by conducting the test for WDE characteristics of structures.

FIG. 4 is a model of flow passage in last stage of a steam turbine and the division of inlet section.

FIG. 5 shows the erosion rate distribution on suction surface of rotor blade in last stage of a steam turbine.

FIG. 6 is a three-dimensional model diagram of structures designed specifically against WDE.

FIG. 7 is a histogram of cumulative volume loss of different structures after the WDE test.

FIG. 8 is a radar chart of WDE resistance of different structures after the WDE test.

FIG. 9 is a schematic diagram of a layout of structures in last stage blade of a steam turbine.

### DETAILED DESCRIPTION OF THE EMBODIMENTS

### Example

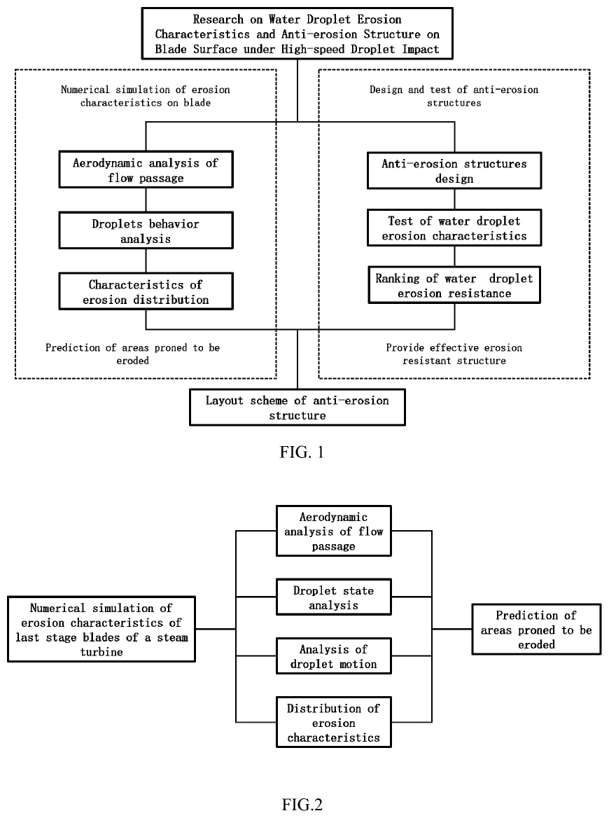

FIG. 1 is a flow chart of a customized method for strengthening the WDE resistance on steam turbine blade surfaces. And it includes the following steps as the figure shows:

Step S1: analyzing blade surface erosion characteristics of the blade to be optimized, and predicting water erosion-prone areas on the surface of the blade to be optimized.

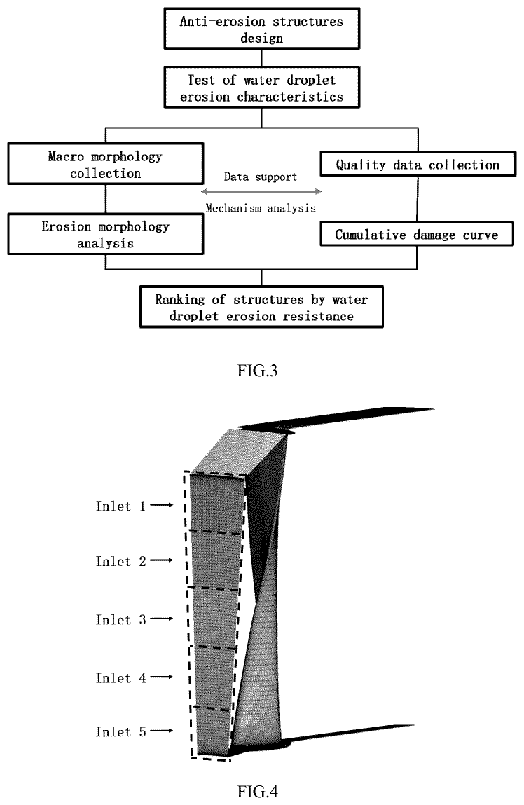

FIG. 2 is a flow chart of numerical analysis about erosion characteristics on blade surfaces. As shown in FIG. 2, step S1 also can be divided into following steps:
Step S11: obtaining the model and operating condition parameters of the last stage including rotational speed, inlet total pressure, inlet total temperature, inlet humidity and outlet pressure.
Step S12: carrying out numerical simulation of the last stage flow passage in accord with parameters mentioned above to obtain the flow characteristics and humidity distribution of wet steam. As the WDE is mainly brought by secondary water droplets formed by torn water film near the trailing edge of stator blade, the aim of simulation is to acquire the deposition and movement characteristics of water film deposited on the surface near the trailing edge of stator blade.
Step S13: dividing the outlet of stator blade into several sections along radial direction and using it as the inlets for the simulation for erosion characteristics of rotor blade. Every section has its own inlet condition. As shown in FIG. 4, this outlet is divided into 5 different inlet sections.
Step S14: based on the deposition and movement characteristics of water film acquired in step S12, and the shear force of the mainstream steam, the centrifugal force and the axial clearance between the stator and rotor blade, size and mass flow rate of the droplet corresponding to each section are calculated respectively.
Step S15: the size and mass flow rate calculated above are used as the inlet condition for the simulation for erosion characteristics of rotor blade to imitates the motion of droplets in flow passage of rotor blade. Droplets are added to the corresponding sections referring to the motion of mainstream steam at the inlet section and the motion difference between harmful droplets and mainstream when simulation.
Step S16: determining the control parameters of the Finnie erosion model according to mechanical properties of blade materials. Based on the movement of droplets in flow passage of rotor blade combined with Finnie erosion model, numerical simulation is conducted to obtain the erosion characteristics on rotor blade surfaces, particularly the erosion rate distribution of rotor blade surfaces, so as to determine the water erosion prone area on the blade surface. As shown in FIG. 5, impact of droplets mainly occurs in the area closer to the top of suction surface on rotor blade, which implies that a large number of droplets will gather toward the top blade and indicates the centrifugal force will influence the trajectory of harmful droplets in larger size when flowing in flow passage. At the same time, the absolute velocity of droplets is smaller than mainstream steam under the effect of viscous force in the leading edge of stator blade, and the direction of droplet motion is deflected. As a result, impact behavior of droplets mainly occurs in the leading edge of suction surface on rotor blade. Therefore, using numerical simulation of erosion characteristics, the water erosion-prone area can be predicted in the leading edge of suction surface near the top of rotor blade.

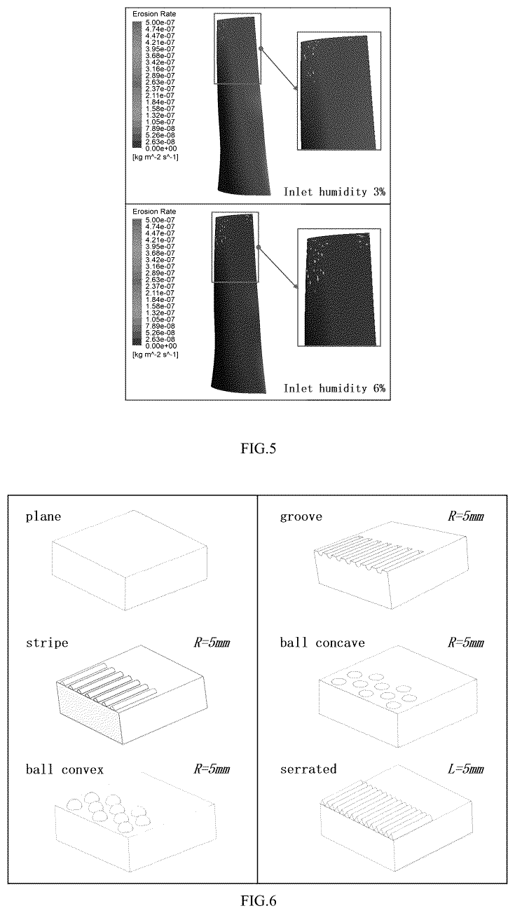

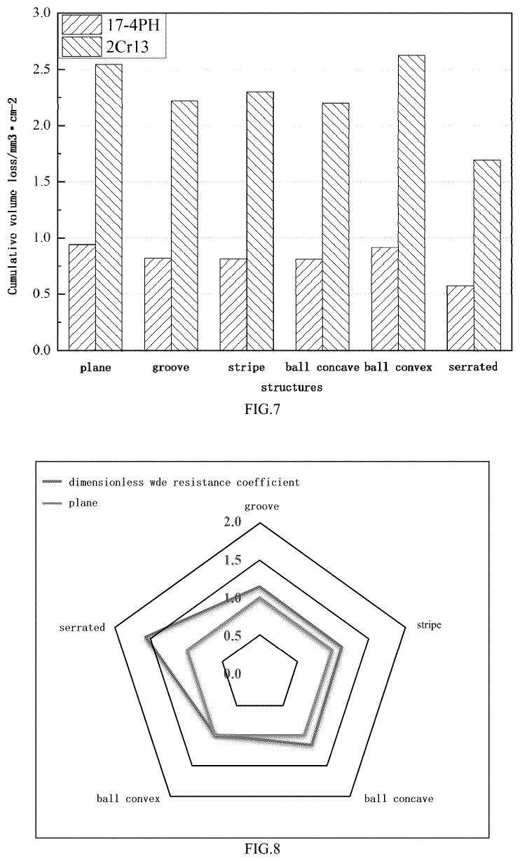

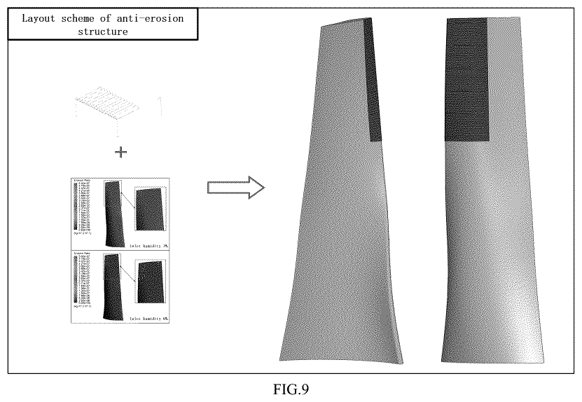

Step S2, designing the structures against WDE, and screening the most effective one through the test of WDE characteristics. FIG. 3 is a flow chart of process to screen the most effective one by conducting the test for WDE characteristics of structures. Step S2 specifically includes as shown in FIG. 3:
Step S21: designing several structures against WDE considering droplet size, including groove, stripe, dimple, protrusion and serrated structure, as shown in FIG. 6. The designed structures should facilitate to the formation of a buffer water cushion, minimize the impact angle, and the size should be slightly larger than size of droplet to block the formation of lateral jet. The flat specimen represents blade surface before optimization and is used for comparison with the designed structures against WDE.
Step S22: the impact parameters are obtained by numerical simulation of erosion characteristics in step S16, including impact angle, relative impact velocity, and droplet diameter.
Step S23: According to impact parameters obtained in step S22, adjusting parameters and dimensions of components in the experimental rig for testing WDE characteristics to adapt to conditions in the test. Parameters of each component include liquid-solid impact angle and liquid-solid impact velocity. Adjusting dimensions including droplet diameter, which is acquired in step S22.
Step S24: using cumulative volume loss and the dimensionless WDE resistance coefficient combined with macroscopic surface characteristics of the specimens to analyze the WDE resistance of different structures and rank the strength. As shown in FIGS. 7-8, WDE resistance of the above-mentioned different structures were tested, and the cumulative volume loss showed that the serrated structure could significantly improve WDE resistance made by 17-4 PH or 2Cr13.

The dimensionless WDE resistance coefficient is calculated as:

$${N}_{PE} = ( {E}_{1} / {E}_{10} + {E}_{2} / {E}_{20} ) / 2$$

Among them, N_{PE} is the dimensionless WDE resistance coefficient, E₁ [symbol] E₂ are the cumulative volume loss of a kind of structure specimen made by 17-4 PH and 2Cr13 respectively; E₁₀ [symbol] E₂₀ are the cumulative volume loss of flat specimen made by 17-4 PH and 2Cr13 respectively. From the radar chart, it can be seen that the serrated structure is outstanding for the improvement of WDE resistance.

Step S25: screening out the most effective structure under the test condition. Five kinds of structures tested were ranked by WDE resistance from strong to weak: serrated>dimple>groove>stripe>plane>protrusion, which means the tight (no interval) side-by-side uniform distribution of serrated structure is the most effective structure against WDE.

Step S3, according to the areas detected in Step S1, selecting a suitable and effective structure and determining where and how to arrange. As shown in FIG. 9, based on numerical simulation of erosion characteristics for a steam turbine, areas prone to be eroded could be detected in the leading edge of suction surface near the top of rotor blade. And the tight (no interval) side-by-side uniform distribution of serrated structure is the most effective structure against WDE in the light of the test of WDE characteristics. Therefore, considering the research results of these two aspects, the layout of structures against WDE shown in the figure is obtained.

Therefore, a customized method for strengthening the WDE resistance on steam turbine blade surfaces is proposed, which predicts areas prone to be eroded of blades by numerical simulation, and arranges the structures screened out by test of WDE characteristics to improve the WDE resistance of blades. The method mitigates the WDE problem purposefully, and only arranges a small number of special structures in local areas that minimizes the cost and influence on steam turbine blades as far as possible.

Finally, it should be claimed that the example mentioned above is merely used to illustrate the technical scheme of this method, but not to limit it. Although it has been described in detail with reference to the preferred example, those skilled in the art should understand that they can still modify the technical scheme of this method, and these modifications or equivalent replacements cannot make the modified technical scheme depart from the scope of the technical scheme of this method.

What is claimed is:

1. A customized method for strengthening resistance to water droplet erosion (WDE) on steam turbine blade surfaces comprising the following steps:
step S1, carrying out a numerical analysis on erosion characteristics of the steam turbine blade surfaces to detect a plurality of areas prone to erosion by water droplets;
step S2, designing a plurality of corresponding structures against the WDE, and conducting a test for WDE characteristics of the plurality of corresponding structures to screen for effective corresponding structures;
step S3: according to the plurality of areas detected in Step S1, selecting a plurality of suitable and effective structures based on the test and determining where and how to arrange the plurality of suitable and effective structures.

2. The customized method according to claim 1, wherein step S1 comprises the following substeps:
step S11: obtaining a model and operating condition parameters of a last stage of a flow passage;
step S12: carrying out a numerical simulation of the flow passage in the last stage in accord with according to the operating condition parameters from step S11 to obtain flow characteristics and a humidity distribution of a wet steam in the last stage; acquiring deposition and movement characteristics of a water film deposited on a surface near a trailing edge of a stator blade;
step S13: dividing an outlet of the stator blade into a plurality of sections along a radial direction and using the outlet as inlets for a simulation for erosion characteristics of a rotor blade; wherein every section of the plurality of sections has an inlet condition;
step S14: based on the deposition and movement characteristics of the water film acquired in step S12, and a shear force of a mainstream steam, a centrifugal force and an axial clearance between the stator blade and the rotor blade, calculating a size and a mass flow rate of each droplet corresponding to each section; step S15: considering a motion of the water droplets in the flow passage of the rotor blade, the size and the mass flow rate calculated above are added to corresponding inlet sections referring to a motion of the mainstream steam and a difference in motion between harmful droplets and mainstream in the corresponding inlet sections when simulation;
step S16: determining parameters for a Finnie erosion model according to mechanical properties of blade materials; combining the Finnie erosion model with movement characteristics of the water droplets in the flow passage of the rotor blade, and conducting a numerical simulation to obtain erosion characteristics of rotor blade surfaces, particularly an erosion rate distribution of the rotor blade surfaces, to determine the plurality of areas prone to erosion.

3. The customized method according to claim 2, wherein the operating condition parameters of step S11 comprise a rotational speed, an inlet total pressure, an inlet total temperature, an inlet humidity, and an outlet pressure.

4. The customized method according to claim 3, wherein step S2 further comprises the substeps:
step S21: designing the plurality of corresponding structures against the WDE;
step S22: obtaining impact parameters from the numerical simulation of the erosion characteristics in step S16.
step S23: changing parameters and components in an experimental rig used for testing the WDE characteristics to adapt to conditions in the test.
step S24: using a cumulative volume loss and a dimensionless WDE resistance coefficient to analyze the resistance to the WDE of different structures and ranking the different structures in order in combination with macroscopic surface characteristics of specimens;
step S25: screening out a most effective structure under test conditions.

5. The customized method according to claim 4, wherein the impact parameters of the water droplets on blade surface mentioned in step S22 comprise an impact angle, a relative impact velocity, and a droplet size; and wherein the parameters and components of the experimental rig changed in Step S23 comprise a liquid-solid impact angle a liquid-solid impact velocity, and a droplet size.

6. The customized method according to claim 5, wherein the parameters considered in designing structures against the WDE comprise a groove, a stripe, a dimple, a protrusion, and a serrated structure.

7. The customized method according to claim 4, wherein in step S24:
the dimensionless WDE resistance coefficient is calculated as follows:
$${N}_{PE} = ( {E}_{1} / {E}_{10} + {E}_{2} / {E}_{20} ) / 2 ;$$
wherein N_{PE} is the dimensionless WDE resistance coefficient, E₁ and E₂ are a cumulative volume loss of a structure specimen made by two different materials; E₁₀ and E²⁰ are a cumulative volume loss of flat specimen made by the two different materials.
